(19) United States
(12) Patent Application Publication
(10) Pub. No.: US 2007/0297635 A1
(43) Pub. Date: Dec. 27, 2007

(54) Speaker device

(75) Inventor: Mitsuru Kano, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/808,315

(22) Filed: Jun. 8, 2007

(30) Foreign Application Priority Data
Jun. 26, 2006 (JP) JP 2006-174870

(51) Int. Cl. H04R 1/02

(52) U.S. Cl. 381/394; 381/395

(57) ABSTRACT

A speaker device includes a speaker unit and a speaker device bracket mounted thereon. The speaker device bracket has a condenser fixing part for fixing a network electronic part such as a condenser, and a connector terminal fixing part for fixing a speaker device connector terminal which is electrically connected to an amplifier and a voice coil. Thus, both of the condenser and the connector terminal can be fixed to the speaker unit by using a speaker device component part being one dedicated part, and the number of parts of the speaker device and the number of procedures can be reduced. Additionally, by providing the fixing parts at appropriate positions of the speaker device bracket, the mounting freedom degree of the network electronic part can be improved.

### BACKGROUND OF THE INVENTION

1. Field of the Invention

The present invention relates to a fixing configuration of a network electronic part and a connector terminal in a speaker device.

2. Description of Related Art

Conventionally, a network electronic part (also referred to as “network element”), such as a choke coil, a condenser and a resistor, and a speaker device component part, such as a speaker device connector terminal, are sometimes provided in a speaker device.

The network electronic part of the speaker device component parts has a function to control a sound signal inputted to the speaker device, e.g., a function to convert the sound signal supplied from an amplifier into a predetermined signal. A speaker unit having a configuration in which the network electronic part is mounted on an outer or inner part of a speaker frame and is covered with a protective cover, as need arises, is disclosed in Japanese Patent Application Laid-open under No. 2002-142284 (Reference-1).

Meanwhile, the speaker device connector terminal is electrically connected to a voice coil via a pair of plus and minus wirings, and it also engages with a sound signal supplying connector terminal of the amplifier to be electrically connected thereto. Hence, the speaker device connector terminal functions as a relay terminal which supplies a sound signal outputted from the amplifier to the voice coil.

In the speaker unit according to Reference-1, the network electronic part is mounted on the outer or inner part of the speaker frame. However, according to the type of the speaker unit, the network electronic part becomes unnecessary. Therefore, the configuration for mounting the network electronic part on the speaker frame is not desired in such a viewpoint that the speaker frame serves as a flexible component part.

As shown in FIG. 1A of Reference-1, the wiring connected to the speaker device terminal is provided in the speaker unit. When the speaker device connector terminal is provided at the point of the wiring, it becomes necessary to provide a dedicated part for fixing the speaker device connector terminal.

Therefore, in the speaker unit, when both of the network electronic part and the speaker device connector terminal have to be provided, the configuration of mounting or fixing them becomes necessary for each part. Thus, it is problematic that the number of parts and the number of procedures increase and the flexibility of the speaker device component part becomes low.

### SUMMARY OF THE INVENTION

The present invention has been achieved in order to solve the above problem. It is an object of this invention to provide a speaker device including a speaker device component part capable of fixing a network electronic part and a speaker device connector terminal without increasing the number of parts and the number of procedures.

According to one aspect of the present invention, there is provided a speaker device including: a speaker unit; and a speaker device component part which is mounted on the speaker unit, wherein the speaker device component part includes a network electronic part fixing part for fixing a network electronic part and a connector terminal fixing part for fixing a speaker device connector terminal.

In the general speaker device, the condenser being as an example of the network electronic part is sometimes directly connected to the plus and minus terminal metals of a speaker device terminal substrate to be fixed thereto. In this case, since the mounting position of the condenser in the speaker device is limited to the vicinity of the speaker device terminal substrate, the mounting freedom degree of the condenser in the speaker device problematically becomes low. In addition, in the case of an on-vehicle speaker device, since the speaker device is mounted on a limited narrow space (e.g., on the inner panel) on the vehicle, it is problematically difficult to mount the large-sized condenser on the speaker device.

In the general speaker device, the connector terminal is mounted on and fixed to the speaker device via the dedicated part such as a connector mounting bracket. Therefore, since the connector mounting bracket being the dedicated part for fixing the connector terminal has to be provided, the number of parts of the speaker device problematically increases by the amount.

Particularly, in the speaker device, when both of the network electronic part such as the condenser and the connector terminal are necessary, both of a condenser fixing dedicated part for fixing the condenser and the connector terminal fixing dedicated part for fixing the connector terminal become necessary, and it is problematic that the number of parts increases and the number of procedures also increases by the amount.

In this point, the speaker device includes the speaker unit and the speaker device component part which is mounted on the speaker unit, and the speaker device component part includes the network electronic part fixing part for fixing the network electronic part such as the condenser, the resistor and the coil, and the connector terminal fixing part for fixing the speaker device connector terminal, which is electrically connected to the amplifier and the voice coil, respectively.

Thus, unlike the above-mentioned general speaker device which fixes each of the network electronic part such as the condenser and the connector terminal to the speaker unit with using separate dedicated parts, both of the network electronic part such as the condenser and the connector terminal can be fixed to the speaker unit with using one dedicated part, i.e., the speaker device component part. Therefore, as compared with the above-mentioned general speaker device, the number of parts of the speaker device can be reduced, and the part cost and the number of procedures can be accordingly reduced.

In the speaker device, the setting positions of the network electronic part fixing part and the connector terminal fixing part with respect to the speaker device component part are not limited. Thus, in accordance with the specification of the speaker device, each of the network electronic part fixing part and the connector terminal fixing part can be freely set at an appropriate position of the speaker device component part, e.g., at a position having a sufficient space. Thereby, the mounting freedom degree of the network electronic part and the connector terminal with respect to the speaker unit can be improved. Hence, the large-sized network electronic part and connector terminal can be also mounted.

In a manner of the above speaker device, the speaker device component part may include a wiring fixing part for fixing a speaker device wiring which connects the speaker device terminal, the network electronic part and the connector terminal, electrically connected to the voice coil, for example. In a preferred example, the speaker unit may include a speaker device terminal which is electrically connected to a voice coil, and the wiring fixing part may be provided at a position in a vicinity of each of the speaker device terminal, the network electronic part fixing part and the connector terminal fixing part. Therefore, by fixing the speaker device wiring to the wiring fixing part, saving of the space of the electric circuit component part of the speaker device can be realized.

In another manner of the above speaker device, the speaker unit may include a magnetic circuit including a variant magnetic body having a function to position the speaker device component part with respect to a circumferential direction of the speaker unit, and an inner part of the speaker device component part may be formed into a shape engaging with the variant magnetic body.

In this manner, the speaker unit includes the magnetic circuit including the variant magnetic body (e.g., a variant plate) having the function to position the speaker device component part with respect to the circumferential direction of the speaker unit. The variant magnetic body has a shape different from the annular magnetic body. In a preferred example, the outer shape of the variant magnetic body is a shape formed by integrating the plural half-circles with the circle. The inner part of the speaker device component part is formed into a shape engaging with the variant magnetic body. Therefore, when the speaker device component part is mounted on the speaker unit, the shape of the variant magnetic body becomes the positioning guide (offset line), and it becomes possible to easily position the speaker device component part with respect to the circumferential direction of the speaker unit.

In a preferred example, in such a state that the variant magnetic body and the inner part engage with each other, the speaker device component part may be mounted on the speaker unit at a position covering at least one part of the magnetic circuit positioned on a side opposite to a sound output side.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a cross-sectional view of a speaker device including a speaker device bracket according to an embodiment of the present invention;

FIG. 2 shows a perspective view of the speaker device including the speaker device bracket according to this embodiment when observed from a rear side; and

FIGS. 3A and 3B show a front view and a rear view of the speaker device bracket according to this embodiment, respectively.

### DETAILED DESCRIPTION OF THE PREFERRED EMBODIMENTS

Now, a preferred embodiment of the present invention will be described below with reference to the attached drawings.

### [Configuration of Speaker Device]

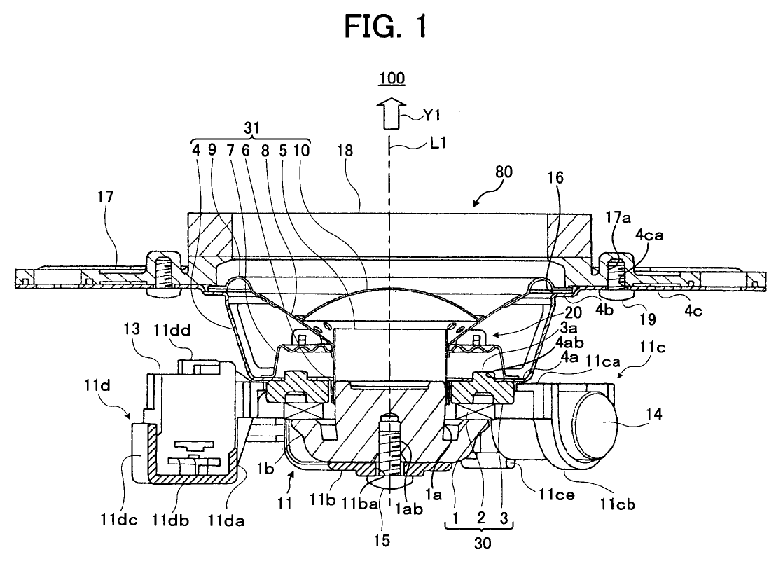

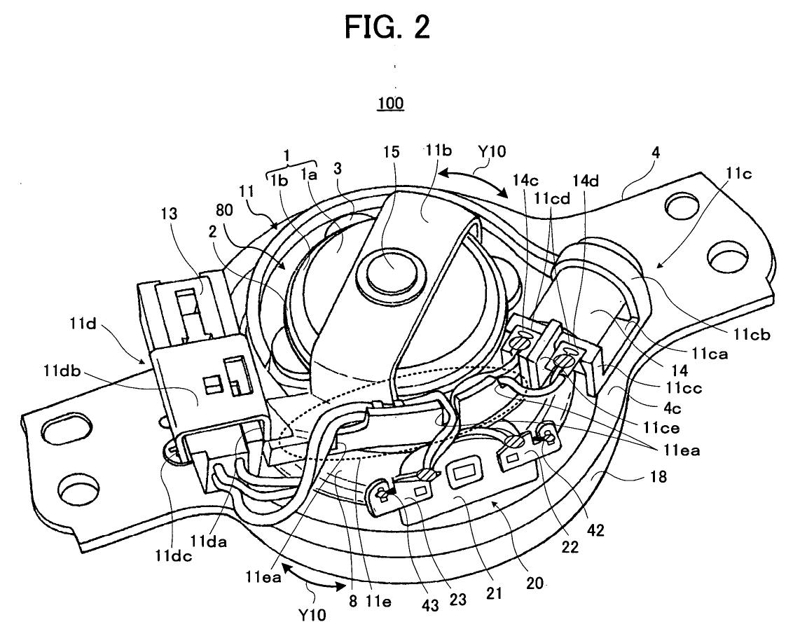

FIG. 1 shows a cross-sectional view of a speaker device 100 including a speaker device bracket 11 being an example of a speaker device component part according to an embodiment of the present invention when cut by a plane surface passing through a central axis L1 thereof. FIG. 2 shows a perspective view on a rear side of the speaker device 100 shown in FIG. 1, when observed from a side opposite to a sound output side.

As shown in FIG. 1, the speaker device 100 includes a speaker unit 80 and a speaker device bracket 11 mounted on the speaker unit 80. The speaker unit 80 includes a magnetic circuit 30 having a yoke 1, a magnet 2 and a variant plate 3; a frame 4; a vibration system member 31 having a voice coil bobbin 5, a voice coil 6, a damper 7, a diaphragm 8, an edge 9 and a cap 10; and other component members.

As the other component members, there are packings 16 and 17, a cushion member 18, a speaker device terminal 20 including a terminal substrate 21 on which a plus terminal metal 22 and a minus terminal metal 23 are mounted, a speaker device connector terminal 13 connected to a connector terminal (not shown) connected to an output wiring of an amplifier, a condenser (network electronic part) 14 including plus and minus terminals (not shown), a plus terminal metal 14c for condenser connection and a minus terminal metal 14d for condenser connection, and male screws 15 and 19.

First, a description will be given of the configuration of the speaker unit 80. In the present invention, the configuration of the speaker unit 80 and the driving system thereof are not limited.

Now, the configuration of the magnetic circuit 30 will be explained.

The magnetic circuit 30 is formed as an external-magnet type magnetic circuit.

The yoke 1 includes a pole part 1a formed into a substantially cylindrical shape, and a flange part 1b outwardly and obliquely upwardly extending from the lower end part of the outer peripheral wall of the pole part 1a. A female screw (screw hole) 1ab engaging with the male screw 15 is formed at the pole part 1a.

The magnet 2, formed into a substantially annular shape, is mounted on the flange part 1b. The variant plate 3 is mounted on the magnet 2. The variant plate 3 has a shape different from the annular plate. In this embodiment, the outer shape of the variant plate 3 has a shape formed by integrating plural half-circles with a circle, and it has a function to position the speaker device bracket 11 with respect to the circumferential direction (an arrow Y10 direction shown in FIG. 2) of the speaker unit 80. In addition, a protruding part 3a, formed into a cylindrical shape and having a function to caulk and fix the frame 4 to the variant plate 3, is provided on the upper surface of the variant plate 3. A magnetic gap 32 on which the magnetic flux of the magnet 2 concentrates is formed in a gap between the inner peripheral wall of the variant plate 3 and the outer peripheral wall of the pole part 1a.

Next, a description will be given of the configuration of the frame 4. The frame 4 has a function to support various kinds of component members for speaker device. The frame 4, having a substantially bowl shape and a step-state cross-section, includes a first step part 4a provided on the lower end side, a second step part 4b provided on the upper side and the outer side of the first step part 4a, and a third step part 4c provided on the upper side and the outer side of the second step part 4b. Openings 4ab engaging with the protruding part 3a of the variant plate 3 are provided at the first step part 4a. Openings 4ca for inserting the male screws 19 are provided at the third step part 4c. In such a state that the protruding part 3a is inserted into the opening 4ab being the component of the frame 4 and the first step part 4a and the variant plate 3 contact with each other, the frame 4 is mounted on the variant plate 3.

Next, the configuration of the vibration system member 31 will be explained below.

The voice coil bobbin 5 is formed into a substantially cylindrical shape. The vicinity of the lower end part of the voice coil bobbin 5 covers the vicinity of the upper end part of the pole part 1a of the yoke 1. Thereby, the vicinity of the lower end part of the inner peripheral wall of the voice coil bobbin 5 is opposite to the vicinity of the upper end part of the outer peripheral wall of the pole part 1a, and the vicinity of the lower end part of the outer peripheral wall of the voice coil bobbin 5 is opposite to the inner peripheral wall of the variant plate 3 and the part of the inner peripheral wall of the magnet 2, respectively.

The voice coil 6 is wound around the vicinity of the lower end part of the outer peripheral wall of the voice coil bobbin 5, and the outer peripheral wall of the voice coil 6 is opposite to the inner peripheral wall of the variant plate 3. The voice coil 6 includes one wiring including plus and minus lead wires (not shown). The plus lead wire is an input wiring of an L (or R) channel signal, and the minus lead wire is an input wiring of a ground (GND) signal. Each of the plus and minus lead wires is electrically connected to a plus tinsel cord 42 and a minus tinsel cord 43 via soldering (a hatched part shown in FIG. 2, which is same hereinafter), and the plus tinsel cord 42 and the minus tinsel cord 43 are electrically connected to the plus terminal metal 22 and the minus terminal metal 23 mounted on the terminal substrate 21 of the speaker device terminal 20 provided in the vicinity of the first step part 4a of the frame 4 by soldering. The plus terminal metal 22 is electrically connected to the plus terminal metal 14c connected to the connector terminal 13 and the plus terminal of the condenser 14 via the soldering and the wiring, and the minus terminal metal 23 is electrically connected to the connector terminal 13 through the soldering and the wiring. In addition, the minus terminal metal 14d for condenser connection is connected to the connector terminal 13 through the soldering and the wiring. Thereby, one-channel signal and power (sound current) are inputted to the voice coil 6 from the amplifier via the condenser 14.

The damper 7 is formed into a substantially annular shape. The outer peripheral part of the damper 7 is mounted on the first step part 4a of the frame 4, and the inner peripheral edge part of the damper 7 is mounted on the vicinity of the upper end part of the outer peripheral wall of the voice coil bobbin 5. Thereby, the damper 7 has a function to elastically support the voice coil bobbin 5.

The diaphragm 8, formed into a cone shape, has a function to output an acoustic wave corresponding to the input signal. The inner peripheral edge part of the diaphragm 8 is mounted on the upper end part of the outer peripheral wall of the voice coil bobbin 5. An edge 9, having a substantially Ω-shaped cross section and made of a material such as a rubber, is mounted on the outer peripheral edge part of the diaphragm 8. The outer peripheral edge part of the edge 9, having an annular shape, is mounted on the third step part 4c of the frame 4 via the packing 16 made of a resin material.

The cap 10 has a dome shape, and the vicinity of the outer peripheral end part thereof is mounted on the sound output surface of the inner peripheral part of the diaphragm 8, being on the sound output side. Therefore, the cap 10 has a function to prevent moisture and foreign material from entering the magnetic circuit 30 from the sound output side.

The packing 17, having an annular shape, is made of a resin material. The packing 17 has male screws (screw holes) 17a at positions corresponding to the openings 4ca provided at the third step part 4c of the frame 4. The male screw 19 is inserted into the opening 4ca from the rear side of the third step part 4c of the frame 4 to engage with the male screw 17a. Thereby, the packing 17 is mounted on the third step part 4c of the frame 4.

The cushion member 18, formed into a pole shape, is deformed into an annular shape to be mounted on the packing 17.

The speaker device bracket 11, made of a resin material, mainly has a connector terminal fixing part 11d for fixing the connector terminal 13, and a condenser fixing part 11c for fixing the condenser 14. The speaker device bracket 11, which holds the connector terminal 13 and the condenser 11, is mounted on a position which covers at least one part (including the yokel) of the magnetic circuit 30 positioned on the side opposite to the sound output side in the speaker unit 80.

### (Configuration of Speaker Device Bracket)

Next, a description will be given of the configuration of the speaker device bracket 11 being an example of the speaker device component parts according to the embodiment of the present invention, with reference to FIG. 1 to FIGS. 3A and 3B.

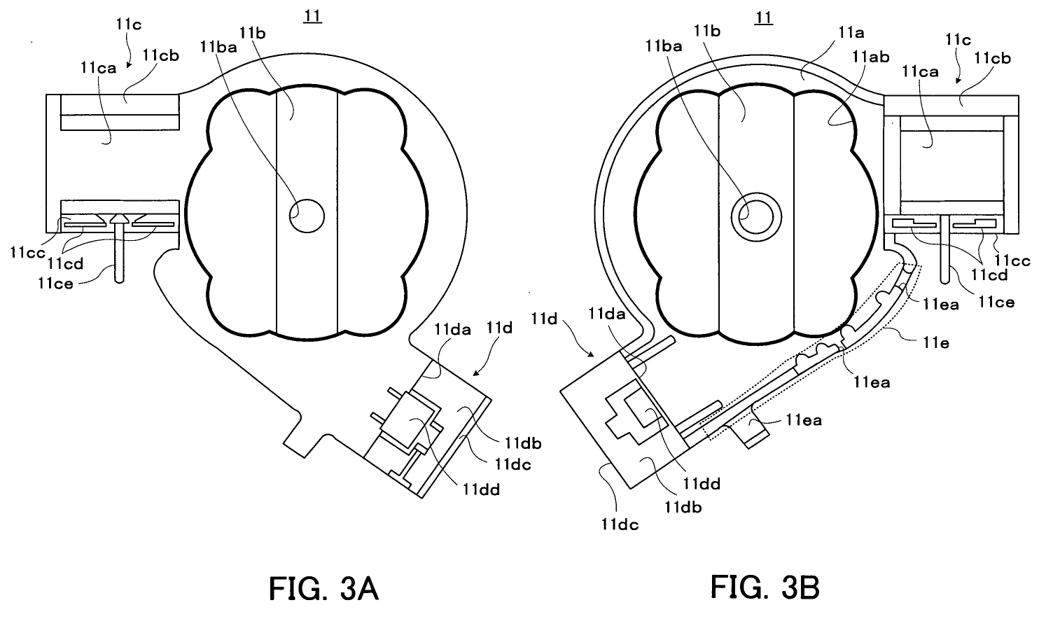

FIG. 3A shows a front view of the speaker device bracket 11 when observed from the side opposite to the arrow Y1 direction shown in FIG. 1. FIG. 3B shows a rear view of the speaker device bracket 11 when observed from the arrow Y1 direction shown in FIG. 1.

The speaker device bracket 11 includes a positioning part 11a, a yoke fixing part 11b, a condenser fixing part 11c, a connector terminal fixing part 11d and a wiring fixing part 11e (a part surrounded by the broken line). The positioning part 11a has a function to position the speaker device bracket 11 with respect to the circumferential direction (the arrow Y10 direction shown in FIG. 2) of the speaker unit 80. The yoke fixing part 11b is provided to stride over the center of the positioning part 11a, and formed into a shape integrated with the opposite part of the positioning part 11a and a shape covering the part of the yoke 1, to be fixed to the yoke 1. The condenser fixing part 11c is provided on the outer side of the positioning part 11a and fixes the condenser 14. The connector terminal fixing part 11d is provided on the outer side of the positioning part 11a and fixes the connector terminal 13. The wiring fixing part 11e is provided between the condenser fixing part 11c and the connector terminal fixing part 11d and fixes various kinds of wirings of the speaker device 100. As the various kinds of wiring of the speaker device 100, there are wirings electrically connected to the condenser 14, the speaker device terminal 20 and the connector terminal 13, respectively.

The positioning part 11a is formed into a substantially annular shape, and an inner part 11ab thereof is formed into a shape engaging with the outer shape of the variant plate 3. Namely, the inner part 11ab of the positioning part 11a has a shape formed by hollowing a shape formed by integrating plural half-circles with a circle. Namely, the inner part 11ab of the positioning part 11a becomes an offset line of the variant plate 3.

An insertion hole 11ba into which the male screw 15 is inserted is provided at the center of the yoke fixing part 11b. The yoke fixing part 11b is positioned at a position covering the part of the rear surface of the yokel positioned on the side opposite to the sound output side. The male screw 15 is inserted into the insertion hole 11ba from the rear side of the yoke fixing part 11b, and the male screw 15 engages with the female screw 1ab of the yoke 1. Thereby, the yoke fixing part 11b is mounted on the yokel. Hence, it becomes possible that the speaker device bracket 11 is mounted on the rear side of the yoke 1 positioned on the side opposite to the sound output side.

The condenser fixing part 11c has a condenser supporting part 11ca, a condenser positioning regulation part 11cb, a condenser connecting terminal mounting part 11cc, an insertion hole 11cd, and a short-circuit prevention rib 11ce. The condenser supporting part 11ca supports the condenser 14. The condenser positioning regulation part 11cb, having an arch shape, provided on the side into which the condenser 14 is inserted and in the vicinity of the one end side of the condenser supporting part, prevents floating of the condenser 14 and regulates the position of the condenser 14. The condenser connection terminal mounting part 11cc is provided on the side opposite to the side into which the condenser 14 is inserted and in the vicinity of the other end side of the condenser supporting part. The condenser connection terminal mounting part 11cc has the insertion hole 11cd into which the plus and minus terminal metals 14c and 14d for condenser connection are inserted, and the plus terminal metal 14c and the minus terminal metal 14d are attached to the condenser connection terminal mounting part 11cc. The short-circuit prevention rib 11ce is provided between the plus terminal metal 14c and the minus terminal metal 14d and formed into a shape for separating both of the terminal metals to prevent the short circuit of them.

The plus terminal metal 14c and the minus terminal metal 14d are mounted on the condenser connection terminal mounting part 11cc, in a fashion being inserted into the correspondent insertion holes 11cd.

As shown in FIG. 1 and FIG. 2, the condenser 14, having a cylindrical shape, is supported by the condenser supporting part 11ca. In addition, in such a state that the condenser positioning regulation part 11cb prevents the condenser 14 from floating to the side opposite to the sound output side, the condenser 14 is positioned by the condenser fixing part 11c and fixed. The plus and minus terminals (not shown) of the condenser 14 are connected to the plus and minus terminal metals 14c and 14d for condenser connection via soldering. The short-circuit prevention rib 11ce serving as a bulkhead member is provided between the plus terminal metal 14c and the minus terminal metal 14d, and the short-circuit of both of the terminal metals is prevented. The configuration of the condenser fixing part 11c for fixing the condenser 14 which is shown in this embodiment is an example. In the present invention, the fixing configuration of the condenser fixing part 11c for fixing the condenser 14 can employ various kinds of known configurations. Additionally, in the present invention, the setting position of the condenser fixing part 11c in the speaker device bracket 11 is not limited, and the condenser fixing part 11c can be freely set at an appropriate position of the speaker device bracket 11, e.g., at a position having a sufficient space, in accordance with a specification of the speaker device 100.

The connector terminal fixing part 11d, having a shape sandwiching the connector terminal 13, has a first supporting part 11da, a second supporting part 11dc, a third supporting part 11db and a fourth supporting part 11dd. The first supporting part 11da contacts one end surface of the connector terminal 13, and the second supporting part 11dc is provided to be opposite to the first supporting part 11da with a constant space. The third supporting part 11db is provided on each one end side of the first supporting part 11da and the second supporting part 11dc and integrates them, and the fourth supporting part 11dd is provided at a position opposite to the third supporting part 11db and on the other end side of the first supporting part 11da. As shown in FIG. 1 and FIG. 2, the connector terminal 13, having a substantially rectangular shape, is sandwiched by the first supporting part 11da, the second supporting part 11dc, the third supporting part 11db and the fourth supporting part 11dd to be fixed to the connector terminal fixing part 11d. The configuration of the connector terminal fixing part 11d for fixing the connector terminal 13, shown in this embodiment, is only an example. In the present invention, the fixing configuration of the connector terminal fixing unit 11d for fixing the connector terminal 13 can employ various kinds of known configurations. Additionally, in the present invention, the setting position of the connector terminal fixing part 11d in the speaker device bracket 11 is not limited. Therefore, in accordance with the specification of the speaker device 100, the connector terminal fixing part 11d can be freely set at the appropriate position of the speaker device bracket 11, e.g., at the position having the sufficient space.

The wiring fixing part 11e is provided to project from a predetermined position of the positioning part 11a on the side opposite to the sound output side, and has plural sandwiching parts 11ea which sandwich various kinds of wirings of the above speaker device 100. In this embodiment, the wiring fixing part 11e is provided at the position in the vicinity of each of the condenser fixing part 11c and the connector terminal fixing parts 11d. Additionally, when the speaker device bracket 11 is mounted on the speaker unit 80, the wiring fixing part 11e is provided at the position corresponding to the vicinity of the speaker device terminal 20. As shown in FIG. 2, the various kinds of wirings are drawn along the wiring fixing part 11e and sandwiched by the sandwiching parts 11ea being the component thereof to be fixed thereto.

Next, a description will be given of characteristic operation and effect of the speaker device 100 having the speaker device bracket 11 according to the embodiment of the present invention.

In a general speaker device, the condenser serving as an example of the network electronic part is sometimes directly connected to the plus and minus terminal metals of the speaker device terminal substrate and fixed to the speaker device terminal substrate. In this case, since the condenser mounting position in the speaker device is limited to the vicinity of the speaker device terminal substrate, the mounting freedom degree of the condenser in the speaker device problematically becomes low. In addition, in a case of an on-vehicle speaker device, since the speaker device is mounted on a limited narrow space (e.g., on an inner panel) on the vehicle, it is problematically difficult to mount a large-sized condenser on the speaker device.

In the general speaker device, the connector terminal is mounted on and fixed to the speaker device via the dedicated part such as the connector mounting bracket. Thus, since it is necessary to provide the connector mounting bracket being the dedicated part for fixing the connector terminal, the number of components of the speaker device problematically increases by the amount.

Particularly, in the speaker device, when both of the connector terminal and the network electronic part such as the condenser are necessary, both of the condenser fixing dedicated part for fixing the condenser and the connector terminal fixing dedicated part for fixing the connector terminal also become necessary, and the number of parts increases. By the amount, the number of procedures also problematically increases.

In this point, the speaker device 100 of this embodiment includes the speaker unit 80 and the speaker device bracket (speaker device component part) 11 mounted on the speaker unit 80, and the speaker device bracket 11 has the condenser fixing part (network electronic part fixing part) 11c for fixing the condenser 14 being the example of the network electronic part and the connector terminal fixing part 11d for fixing the speaker device connector terminal 13.

Thus, unlike the above general speaker device in which each of the connector terminal 13 and the network electronic part such as the condenser 14 is fixed to the speaker unit 80 by using the separate dedicated parts, both of the connector terminal 13 and the network electronic part such as the condenser 14 can be fixed to the speaker unit 80 by using one dedicated part, i.e., the speaker device bracket 11. Hence, as compared with the above general speaker device, the number of parts of the speaker device 100 can be reduced, and thus, the part cost and the number of procedures can be also reduced.

In this embodiment, since, in accordance with the specification, each of the condenser fixing part 11c and the connector terminal fixing part 11d can be freely set at the appropriate position of the speaker device bracket 11, e.g., at the position having the sufficient space, the mounting freedom degree of the condenser 14 and the connector terminal 13 on the speaker unit 80 can be improved. Therefore, the large-sized condenser 14 and connector terminal 13 can be also mounted thereon.

In addition, the speaker device bracket 11 according to this embodiment has the wiring fixing part 11e for fixing the various kinds of wirings of the speaker device 100. In this embodiment, the wiring fixing part 11e is provided at the position in the vicinity of each of the speaker device terminal 20, the condenser fixing part 11c and the connector terminal fixing part 11d. Thus, by fixing the various kinds of wirings of the speaker device 100 to the wiring fixing part 11e, saving of the space of the electric circuit component part of the speaker device 100 can be realized.

The speaker unit 80 according to this embodiment includes the magnetic circuit 30 including the variant plate (variant magnetic body) 3 having the function to position the speaker device bracket 11 with respect to the circumferential direction (Y10 direction shown in FIG. 2) of the speaker unit 80. The variant plate 3 has a shape different from the annular plate. In a preferred example, the outer shape of the variant plate 3 is preferably a shape formed by integrating the plural half-circles with the circle. The inner part 11ab of the speaker device bracket 11 is formed into a shape engaging with the variant plate 3. Thus, when the speaker device bracket 11 is mounted on the speaker unit 80, the shape of the variant plate 3 becomes a positioning guide (offset line), and it becomes possible to easily position the speaker device bracket 11 with respect to the circumferential direction of the speaker unit 80. In this embodiment, the speaker device bracket 11 is provided at the position covering at least one part of the magnetic circuit 30 positioned on the side opposite to the sound output side in such a state that the variant plate 3 and the inner part 11ab of the speaker device bracket 11 engage with each other to be mounted on the speaker unit 80.

### [Modification]

In the above embodiment, such a case that the condenser 14 is used as the example of the network electronic part has been explained. In the present invention, the network electronic part includes various kinds of electronic parts such as resistor and a coil. Therefore, when it is necessary to fix the various kinds of electronic parts, the network electronic part fixing part corresponding to the various kinds of electronic parts can be set in the speaker device bracket 11 in the present invention.

In the above-mentioned embodiment, as the speaker device component part for fixing the network electronic part and the connector terminal, the speaker device bracket 11 is used. However, the present invention is not limited to this. Namely, in the present invention, the speaker device component part having the function may be a frame for supporting the speaker unit 80 or a speaker box (housing) for housing the speaker unit 80.

Additionally, various kinds of deformations are possible within the range of the contents in the present invention.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-174870 filed on Jun. 26, 2006 including the specification, claims, drawings and summary is incorporated herein by reference in its entirety.

What is claimed is:

1. A speaker device comprising:
a speaker unit; and
a speaker device component part which is mounted on the speaker unit,
wherein the speaker device component part includes a network electronic part fixing part for fixing a network electronic part and a connector terminal fixing part for fixing a speaker device connector terminal.

2. The speaker device according to claim 1, wherein the speaker device component part includes a wiring fixing part for fixing a speaker device wiring.

3. The speaker device according to claim 2,
wherein the speaker unit includes a speaker device terminal which is electrically connected to a voice coil, and
wherein the wiring fixing part is provided at a position in a vicinity of each of the speaker device terminal, the network electronic part fixing part and the connector terminal fixing part.

4. The speaker device according to claim 1,
wherein the speaker unit includes a magnetic circuit including a variant magnetic body having a function to position the speaker device component part with respect to a circumferential direction of the speaker unit, and
wherein an inner part of the speaker device component part is formed into a shape engaging with the variant magnetic body.

5. The speaker device according to claim 4, wherein, in such a state that the variant magnetic body and the inner part engage with each other, the speaker device component part is mounted on the speaker unit at a position covering at least one part of the magnetic circuit positioned on a side opposite to a sound output side.
